(19) United States
(12) Patent Application Publication
(10) Pub. No.: US 2013/0185114 A1
(43) Pub. Date: Jul. 18, 2013

(54) QUALITY IMPROVEMENT SYSTEM WITH EFFICIENT USE OF RESOURCES

(71) Applicants: Hossein J. Sadri, Novi, MI (US); Geoffrey J. Cooper, Canton, MI (US); Michael W. Lorenz, Plymouth, MI (US); Matthew P. Solomon, Brownstown, MI (US); Garett McConnell, Milford, MI (US)

(72) Inventors: Hossein J. Sadri, Novi, MI (US); Geoffrey J. Cooper, Canton, MI (US); Michael W. Lorenz, Plymouth, MI (US); Matthew P. Solomon, Brownstown, MI (US); Garett McConnell, Milford, MI (US)

(73) Assignee: FORD GLOBAL TECHNOLOGIES, LLC, DEARBORN, MI (US)

(21) Appl. No.: 13/351,282

(22) Filed: Jan. 17, 2012

(51) Int. Cl. G06Q 10/00

(52) U.S. Cl. 705/7.26; 705/7.32

(57) ABSTRACT

A method refines performance of a product that includes a plurality of interacting systems. A plurality of system-based FMEAs are developed for the interacting systems, each having system-specific failure modes and corresponding actions for respective ones of the system-specific failure modes. Product feedback from recipients of the product is collected, wherein the product feedback is indicative of product performance shortcomings. A plurality of experts for the respective interacting systems review the product feedback to identify particular system-specific failure modes contained in the plurality of system-based FMEAs that have an influence on the product performance shortcomings. The particular system-specific failure modes identified by the experts are prioritized based on a potential to improve the product performance shortcomings. The corrective actions are pursued for the particular system-specific failure modes according to the prioritization.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to methods of continuously refining a product such as goods or services, and, more specifically, to efficient deployment of resources to increase customer perception of performance, quality, and desirability of a product.

The failure modes and effects analysis (FMEA) process is a well known tool to improve product quality used in both product development and operations management. When used as a noun, an FMEA refers to a report or document containing an analysis as applied to a particular product or process, or any system, sub-system, or components within a product or process. The FMEA process has been widely used for decades in various manufacturing industries to reduce the likelihood of failures occurring in the objects of study. FMEA reduces development time and costs since the most significant failure modes are identified and corrected according to a rational prioritization.

A typical FMEA includes a description of the system being analyzed, a block diagram showing major components or process steps and their relationships, and a FMEA worksheet. The worksheet is organized as a matrix listing the items or functions within the system being analyzed. For each item or function, potential failure modes are listed. The potential failures may be identified based on known generic types of failures, brainstorming by development engineer experts, and historical data for similar systems. For each failure mode, the potential effects of the failure are listed. Each failure mode and its effects are then analyzed according to severity, occurrence, and detection parameters to obtain a risk priority number (RPN) which helps identify the potential failures having the greatest impact. The worksheet also lists any recommended corrective actions, and can be further used to document responsibilities and timing for the corrective actions as well as the results of the correction actions as they are implemented.

A complex product (including its design, manufacturing, and distribution) may be comprised of many interacting systems. The FMEA process may be applied separately to these constituent systems. In the case of an automotive vehicle, the product includes many systems or sub-systems such as a chassis system, an engine system, a steering system, a climate system, a passive restraint system, and others. In addition to these hardware systems, many other types of systems such as the manufacturing processes, logistic processes, shipping processes, and distribution processes are often studied using an FMEA. Furthermore, an FMEA may be done at several different levels within a particular hardware system. For example, an FMEA may be generated for an air conditioning system, with a separate FMEA being performed on an air handling sub-system, and another FMEA for a particular sub-component within a sub-system such as an evaporator. Typically, each FMEA is the responsibility of the experts responsible for designing or implementing each respective system, sub-system, or component.

The provider (i.e., seller) of a product will typically monitor the product performance both prior to and after sale in several different ways. A common metric known as initial quality (IQ) relates to customer satisfaction determined upon initial receipt and use of a product. IQ is measured by obtaining surveys of customers and by independent analysis performed by testing laboratories. Other methods that may be used to identify shortcomings in the performance of a product include monitoring of warranty data (i.e., returns or replacements resulting from actual or perceived failures after sale), Things-Gone-Wrong (TGW) studies, and consumer clinics where potential customers perform pre-sale evaluations of prototype products, for example. As used herein, a shortcoming means any failure, undesired property, insufficient functionality, missing attribute, customer want, unfulfilled expectation, and the like. Whenever the feedback identifies a particular shortcoming, the information may be used to identify an associated system thought to be responsible for a related failure. Then the FMEA for that system may be employed to identify and pursue corrective actions.

A drawback of the conventional use of the FMEA process has been that it may be difficult to match up any particular shortcoming to all the appropriate failure modes in the system-based FMEAs or to otherwise direct information about the shortcoming to the correct group(s) for addressing it. The step of assigning a shortcoming to any particular area for resolution has often been based on intuition and guesswork. Furthermore, pursuing a corrective action recommended in one FMEA may have undesirable consequences with respect to other failure modes from other FMEAs which have not been actively involved in addressing the performance shortcoming. Therefore, excessive resources may be consumed while addressing a problem or the problem may be exacerbated.

### SUMMARY OF THE INVENTION

The present invention employs a symbiotic amalgamation of potentially relevant failure modes from multiple FMEAs into a master FMEA, resulting in improvements over conventional techniques which constrain or limit the range of information to be evaluated to a piece-by-piece or single system basis. The invention leads a focused attack to reduce the largest error drivers (i.e., shortcomings) using actions identified within multiple system-based FMEAs for an entire product umbrella (i.e, all the interacting systems associated with the product performance). Since the present invention looks for the biggest hitters for correcting a shortcoming within a wide range of FMEAs, the potential solutions can be prioritized and an optimum result is obtained. Preferably, engineering trials, evaluations, and optimizations are used to build on historical information and data in order to obtain robust results and to greatly increase the measures of initial quality for all product performance characteristics while efficiently focusing resources. The invention links multiple FMEAs into a master FMEA that is used as a unique tool that can monitor supply-base quality and provide a focused, accountable approach to resolving initial quality issues or other product performance shortcomings via a shared responsibility for implementing the master FMEA between a manufacturer and its suppliers (for design and process, including manufacturing and logistics). Furthermore, when various potential corrective actions within different systems are identified that could achieve a resolution of the shortcoming, the relative merits of the different corrective actions can be weighed and selectively implemented (which was not possible with the conventional use of FMEAs).

In one aspect of the invention, a method is provided for refining a product that is delivered to recipients. The product performance is determined by a plurality of interacting systems. A plurality of system-based FMEAs are developed for the interacting systems, wherein each system-based FMEA includes system-specific failure modes and corresponding actions for respective ones of the system-specific failure modes. Product feedback from recipients is collected after receiving delivery of the product, wherein the product feedback is indicative of product performance shortcomings identified by the recipients. A plurality of experts for the respective interacting systems review the product feedback to identify particular system-specific failure modes contained in the plurality of system-based FMEAs that have an influence on the product performance shortcomings. The particular system-specific failure modes identified by the experts are prioritized based on a potential to improve the product performance shortcomings. The corrective actions are pursued for the particular system-specific failure modes according to the prioritization.

### BRIEF DESCRIPTION OF THE DRAWINGS

FIG. 1 depicts a plurality of interacting systems that go into a product provided to a customer.

FIG. 2 is a block diagram of a quality refinement method of the present invention.

FIG. 3 shows one embodiment of a form for documenting a particular FMEA.

FIG. 4 is a flowchart of one preferred method of the invention.

FIG. 5 is a diagram showing some system-based FMEAs that feed into a master FMEA.

FIG. 6 is a chart showing an expert selection of failure modes from system-based FMEAs to be included in a master FMEA.

FIG. 7 shows relationships between selected failure modes.

FIG. 8 shows a master FMEA.

### DETAILED DESCRIPTION OF PREFERRED EMBODIMENTS

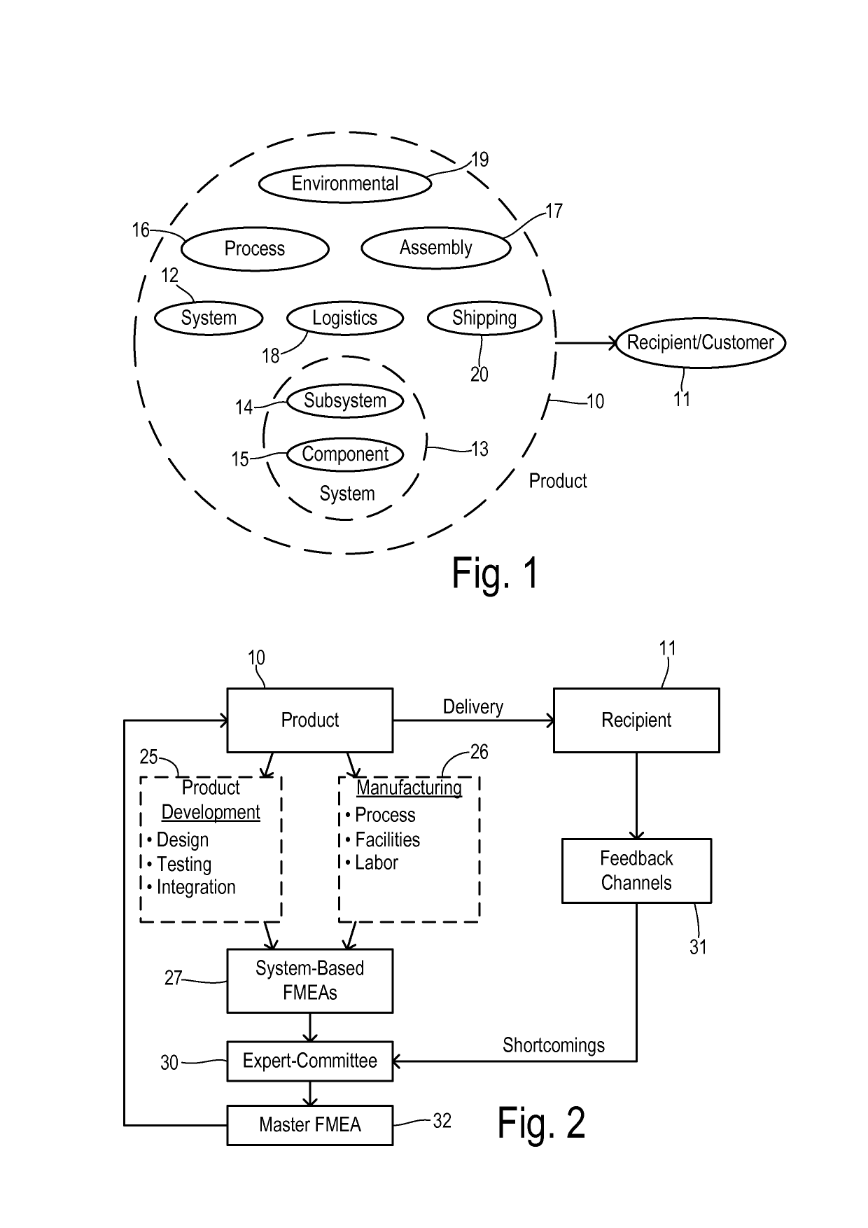

Referring now to FIG. 1, a product 10 is delivered to a customer or other recipient 11. As used herein, product 10 can be any goods or services and recipient 11 can be any internal or external recipient or customer of the goods or services. Product 10 is comprised of a plurality of interacting systems upon which the product performance depends. By way of example, the interacting systems include a first hardware system 12 such as a climate control system in a motor vehicle. Another system 13 such as a climate control system in a motor vehicle may include an HVAC case sub-system 14 which in turn includes an evaporator component 15. Product 10 also includes a process 16 which may be a forming process for a structural component, for example. An assembly system 17 may represent facilities, equipment, and labor involved in manufacturing product 10. A logistics system 18 may define materials supply and handling. An environmental system 19 may involve temperature or air quality conditions during various manufacturing processes or may include the environmental impact associated with scrap and energy use in making product 10, for example. A shipping system 20 relates to the distribution of finished goods.

An FMEA may typically be created corresponding to each individual system with product 10. Thus, a complex array of FMEAs is created by segregated groups of expert personnel wherein there may be little or no interaction between the separate FMEAs or the teams responsible for creating them.

FIG. 2 shows the quality refinement system of the present invention for symbiotically amalgamating elements from various FMEAs into a master FMEA in order to address customer feedback and to drive improvement for initial quality and other performance measures. Product 10 is created by a product development organization 25 and a manufacturing organization 26. Product development organization 25 may be responsible for certain aspects of product 10 including the design, testing, and integration of various systems, sub-systems, and components. Manufacturing organization 26 contributes various processes, facilities, and labor to the success or failure of product 10. Although there may not always be clear separation between product development organization 25 and manufacturing organization 26, and although their responsibilities between design and process issues may overlap, the end result of these typical activities is a plurality of system-based FMEAs 27.

An expert committee 30 is comprised of individuals familiar with respective ones of system-based FMEAs 27. Each expert has a working knowledge of particular ones of FMEAs 27, and committee 30 preferably includes at least one person with expert knowledge for each one of FMEAs 27.

Product 10 is delivered to recipient 11 (whether by sale or other transfer to an end user, a testing lab, or other evaluator) who begins to use/evaluate the goods or services. A plurality of feedback channels 31 are provided between recipient 11 and expert committee 30 in order to identify shortcomings in the product performance as experienced by recipient 11. The feedback channels may include customer surveys (conducted by the manufacturer or a third-party), independent tests, warranty activity, TGW studies, customer clinics, or others. Based on the identified shortcomings, expert committee selects and prioritizes relevant elements from FMEAs 27 to generate a master FMEA 32.

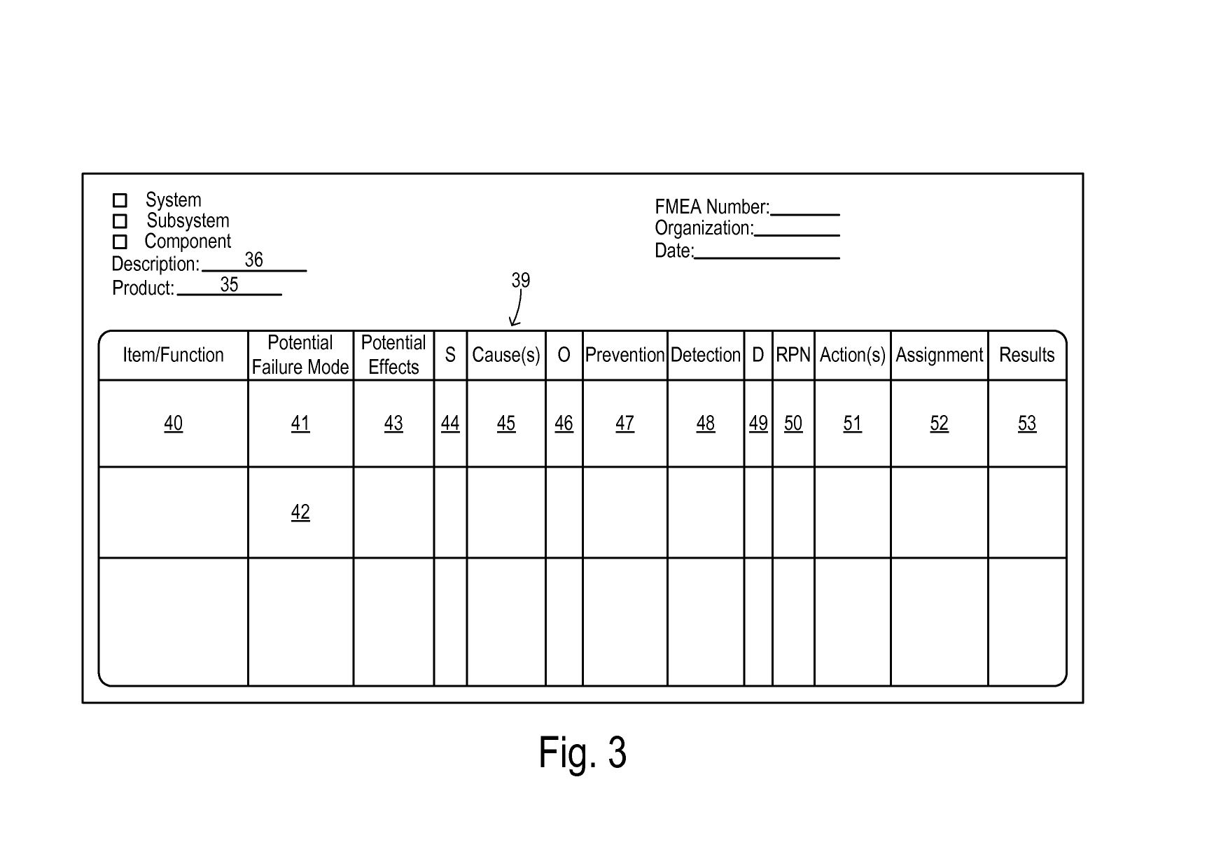

FIG. 3 shows a generic FMEA worksheet as employed in the prior art. The worksheet identifies the analyzed product at 35 and describes the particular system, sub-system, or component at a description entry 36. Other identifying information such as a FMEA number, organization, and date may be provided in a worksheet header. The FMEA itself employs a matrix 39 including various columns and rows to document the analysis as follows. Items or functions within the system are listed in a leftmost column 40. Each item/function may correspond to identified needs, wants, or requirements for the system being analyzed. As used herein, system is broadly meant to refer to any system, sub-system, component, process, or any other constituent elements within a product. The item/function identified in column 40 is preferably phrased as a measurable property and may be determined by a person or team responsible for the system by brainstorming or by review of previous FMEAs for similar items. For an item/function 40, matrix 39 includes a potential failure mode 41 and a potential failure mode 42. Potential failure mode may be identified as an absence of a function, a partial or over-function, a degradation of the function over time, an intermittent function, unintended functions, or other failures that may be determined by the FMEA team. For each potential failure mode, the potential effects of the failure are provided at 43. A Severity S is entered at 44 corresponding to a severity rating for potential effect 43. Potential causes or mechanisms of the failure are identified at 45. The potential occurrence rate of each potential cause or mechanism is entered at 46. The currently known or in-place controls for the prevention and detection of each particular potential cause or mechanism of failure are described at 47 and 48. The ability to detect operation of each potential cause or the failure effect itself is rated at 49. A risk priority number (RPN) 50 is entered into matrix 39 as the product of Severity S, Occurrence O, and Detection D. A higher RPN suggests a higher prioritization so that resources may be applied to reducing the corresponding potential failure modes with the greatest overall risk. Recommended actions for reducing each particular failure mode are provided at 51. When a particular action is going to be executed, an assignment column 52 reflects the identification of a person given responsibility for implementing the recommended action and a target completion date. A results column 53 is provided for entering a brief description of the results of the action taken together with revised Severity S, Occurrence O, and Detection D numbers and a recalculated RPN.

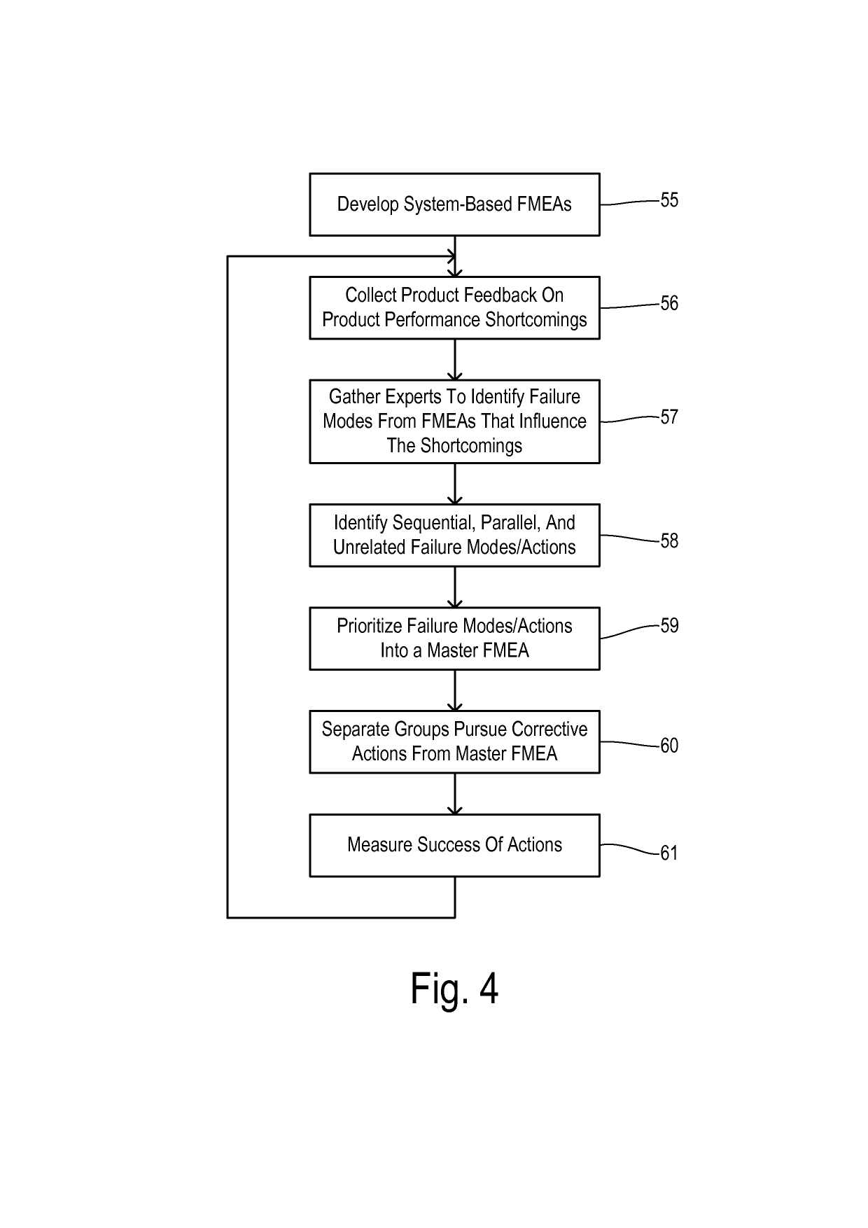

A method of the invention is summarized in the flowchart of FIG. 4. A plurality of system-based FMEAs are developed in step 55 corresponding to a plurality of interacting systems within the product. In step 56, product feedback on the product performance shortcomings is collected. Experts gather together in step 57 to identify failure modes from the separate FMEAs that influence the shortcomings made apparent by the product feedback. The experts review the identified failure modes in order to classify sequential, parallel, and related failure modes or actions in step 58. They agree on a global prioritization for addressing the failure modes and actions and place them into a master FMEA in step 59. The master FMEA is fed back to individual groups across all functions supporting the product, and then the separate groups pursue corrective actions from the master FMEA within their area of responsibility in step 60. The success of the individual actions to address particular failure modes are measured in step 61 to support ongoing work on the master FMEA. On a regular basis, a return is made to step 56 to collect additional product feedback to determine both the success of past actions and to identify any new shortcomings that may arise. Thus, the present invention operates in a dynamic manner that continuously improves and refines the product and its initial quality and customer satisfaction. By prioritizing the use of resources against failure modes in the master FMEA, the most important customer perceived issues are addressed while enabling improved resource efficiency for the manufacturer of the product or provider of the services.

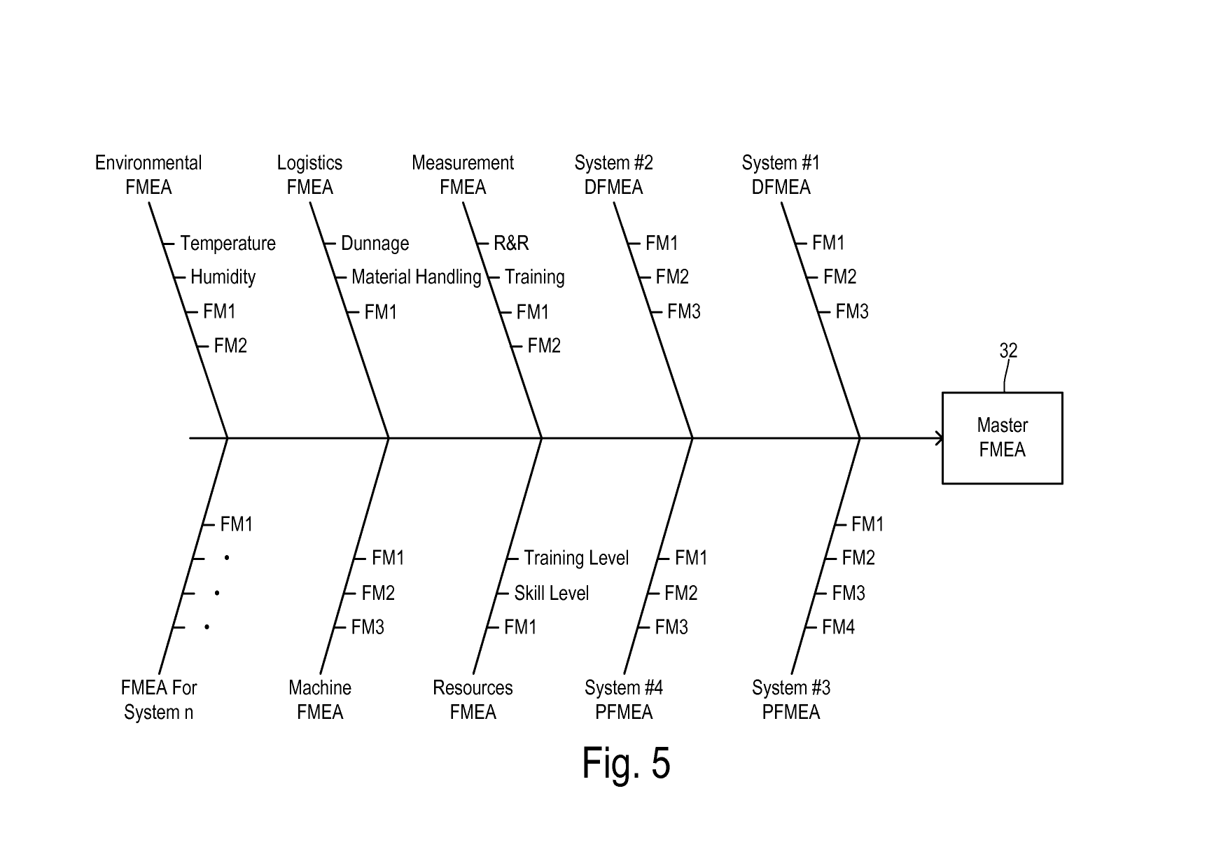

To identify and prioritize the most significant failure modes that address the product performance shortcomings, the experts can utilize other tools or procedures such as a fishbone diagram shown in FIG. 5. In the fishbone diagram, the separate FMEAs are lined up for potential contribution to master FMEA 32. For example, a design FMEA (or DFMEA) for a System #1 has failure modes FM1, FM2, and FM3 that may potentially address a product performance shortcoming as contributed by an expert familiar with System #1. As another example, a System #4 is a process which has a process FMEA (or PFMEA) within which additional failure modes FM1, FM2, and FM3 are determined to be potentially relevant by the expert for System #4. More detailed, specific FMEA examples may include a measurement FMEA, a logistic FMEA, an environmental FMEA, a machine FMEA, and a resource FMEA. FIG. 5 shows some associated failure modes for each one. For example, in an environmental FMEA, typical failure modes may relate to temperature and humidity during a manufacturing operation. Each of the candidate failure modes put forward may be reviewed by the expert committee in view of the relative merits of associated corrective actions, and any potential interaction between corrective actions from one FMEA and failure modes in another FMEA. In particular, the plurality of experts reviews the collective product feedback to identify particular system-specific failure modes contained in the plurality of system-based FMEAs that have the most influence on the product performance shortcomings. Based on the expert knowledge possessed by the experts for the plurality of interacting systems, the identified failure modes to be included in the master FMEA are selected as the ones that best solve the issues raised by the product performance shortcomings while minimizing cost and avoiding unintended consequences for other systems. Prioritization of the particular system-specific failure modes is determined by the experts based on the potential to improve the product performance shortcomings which may be determined by the RPNs of the particular failure modes and/or by group consensus.

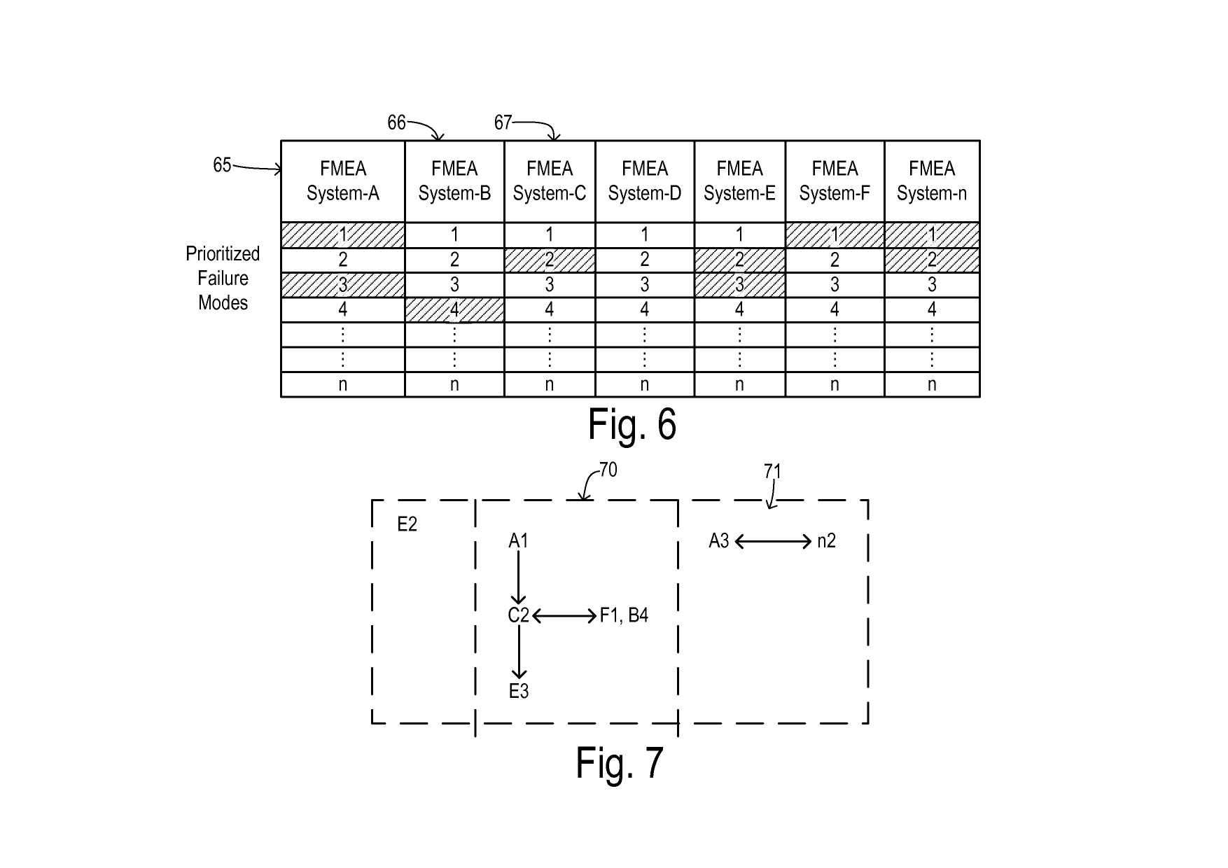

FIG. 6 shows a table useful in analyzing system-based FMEAs. The expert committee can use the table to identify the particular system-specific failure modes to be included in the master FMEA. For example, failure modes for a FMEA on a System A in column 65 include failure modes 1-n. Respective failure modes 1-n are also shown in column 66 for a FMEA on a System B and in column 67 for failure modes relating to a FMEA for a System C. When a particular product performance shortcoming is addressed by the expert committee, each respective expert may highlight certain failure modes in the FMEAs for which they are responsible that contribute to or influence the shortcoming. Thus, in column 65, failure modes 1 and 3 are highlighted, while failure mode 4 is highlighted in column 7, failure mode 2 is highlighted in column 67 and so on. The expert committee as a whole then reviews and discusses each of the candidate failure modes.

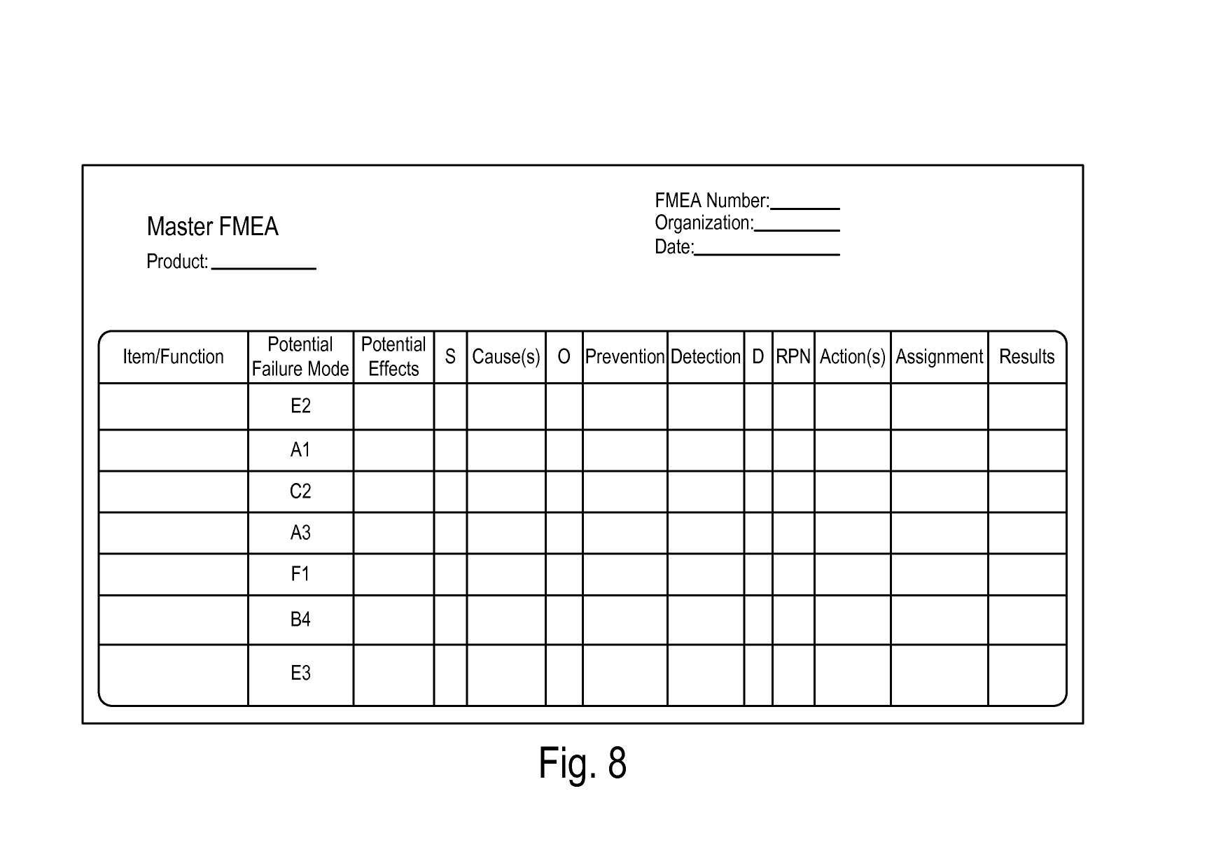

In prioritizing particular system-specific failure modes selected off of individual FMEAs, interrelationships between the corrective actions corresponding to the particular failure modes are identified as shown in FIG. 7. By reviewing the corrective actions, the expert committee identifies any particular sequential order that may be required for adopting the corrective actions. For example, a corrective action relating to a particular manufacturing process being modified may have an effect on another corrective action. FIG. 7 shows the grouping of the particular system-specific failure modes into groups of related failure modes. Thus, a failure mode E2 (i.e., the second failure mode prioritized in the FMEA for System E) is unrelated to other failure modes. Therefore, E2 can be pursued without regard to other actions. In contrast, a group 70 includes a failure mode A1 which must precede the corrective actions for a failure mode C2. Moreover, the expert committee determines that failure mode C2 is to be done in parallel with corrective actions for failure modes F1 and B4. A failure mode E3 is determined to occur in sequential order after failure mode C2. Another group 72 includes failure mode A3 and n2 which are to be pursued in parallel. The prioritization in the master FMEA is determined in response to the sequential order obtained according to FIG. 7. The result is a master FMEA as shown in FIG. 8 (which shows the prioritized failure modes without other data of the FMEA for simplicity). The master FMEA is then used as a multisystem cross-disciplinary tool to manage key critical drivers from all systems simultaneously. It enables resources to be directed efficiently in a focused approach to reduce error and drive improvement and refinements in customer performance feedback such as initial quality indicators. Different groups in the enterprise making or selling the product focus on these key critical contributors identified in the master FMEA, and then they monitor their respective quality measures to ensure success of the corrective actions. The present invention establishes a link between the measured failure modes in the FMEA process with overall quality indicators and customer feedback, thereby driving up measures of quality while efficiently and effectively deploying only the resources necessary to create the improvements.

What is claimed is:

1. A method of refining a product that is delivered to recipients, wherein product performance is determined by a plurality of interacting systems, the method comprising the steps of:
(i) developing a plurality of system-based FMEAs for the interacting systems, wherein each system-based FMEA includes system-specific failure modes and corresponding actions for respective ones of the system-specific failure modes;
(ii) collecting product feedback from recipients after receiving delivery of the product, wherein the product feedback is indicative of product performance shortcomings identified by the recipients;
(iii) a plurality of experts for the respective interacting systems reviewing the product feedback to identify particular system-specific failure modes contained in the plurality of system-based FMEAs that have an influence on the product performance shortcomings;
(iv) prioritizing the particular system-specific failure modes identified by the experts based on a potential to improve the product performance shortcomings; and
(v) pursuing the corrective actions for the particular system-specific failure modes according to the prioritization.

2. The method of claim 1 further comprising the step of:
establishing a master FMEA including the prioritized particular system-specific failure modes.

3. The method of claim 2 further comprising the step of identifying prioritized particular system-specific failure modes to be performed in a sequential order, wherein the prioritizing in step (iv) is in response to the sequential order.

4. The method of claim 1 wherein the product includes a manufactured item, and wherein the system-based FMEAs include a design FMEA and a process FMEA.

5. The method of claim 4 wherein the system-based FMEAs include a tooling FMEA and a logistics FMEA.

6. The method of claim 4 wherein the manufactured product is comprised of components and subsystems, and wherein the system-based FMEAs include a plurality of design FMEAs corresponding to respective components and subsystems.

7. The method of claim 1 wherein the step of collecting product feedback includes selecting data obtained from a customer post-purchase survey.

8. The method of claim 1 wherein the step of collecting product feedback includes selecting data obtained from a product-review clinic.

9. The method of claim 1 wherein the step of collecting product feedback includes selecting data obtained from product warranty activity.

10. The method of claim 1 wherein the step of collecting product feedback includes selecting data obtained from an independent test laboratory.

11. The method of claim 1 further comprising the steps of:
collecting further product feedback after pursuing a corrective action; and
evaluating the success of the pursued corrective action.

12. The method of claim 1 wherein steps (ii), (iii), (iv), and (v) are repeated.
